(19) United States
(12) Patent Application Publication
(10) Pub. No.: US 2009/0061970 A1
(43) Pub. Date: Mar. 5, 2009

(54) Locating Content in Dual Screen Video Game

(75) Inventors: Patrick M. Wylie, Seattle, WA (US); Shawn C. Seavers, Bothell, WA (US)

Correspondence Address: LEE & HAYES, PLLC, 601 W. RIVERSIDE AVENUE, SUITE 1400, SPOKANE, WA, 99201, US

(73) Assignee: Big Fish Games, Inc., Seattle, WA (US)

(21) Appl. No.: 11/849,185

(22) Filed: Aug. 31, 2007

(51) Int. Cl. G06F 17/00

(52) U.S. Cl. 463/1

(57) ABSTRACT

A video game is played with a playing device that includes multiple screens. A background graphic design and partially hidden objects are embedded in the background graphic scene on both the screen displays. One screen displays a zoomed cropped view of the other screen. A textual list of items corresponding to the partially hidden objects is displayed on one screen. The game player provides an input to change one of the displays to another zoomed cropped view of the other screen. The game player selects the partially hidden objects in the screen with cropped view and an indication is provided when each of the partially hidden objects are selected.

### BACKGROUND

Popular electronic video games include hidden object games. These hidden object games display objects hidden in a pictorial background in a game window. A list containing hidden objects is simultaneously displayed in a textual or list window. The objective of the game is for the game player to select the hidden objects in the game window until all the objects on the list are found.

When the hidden objects game is played on a portable device, the portable device's screen is small and difficult to view. Consequently when the hidden objects are displayed, they may be difficult to view and thus impact the game player's enjoyment. Further when the list is simultaneously displayed with the objects, the objects must be significantly reduced in size. Finally, it is desirable to display the entire scene while the game player searches for the objects. Displaying the entire scene plus a list of hidden objects and the objects themselves requires that the objects be shrunk, thus making game play on the mobile device unwieldy.

Illustrated in FIG. 1 is an exemplary display 100 of one scene of an exemplary hidden object video game. The display includes a game window 102 and a list window 104. The game window 102 includes various objects, such as exemplary circle 106a, oval 106b and rectangle 106c. The list window 104 may include text 108 corresponding to the objects 106(a-c) in the game window.

Illustrated in FIG. 2 is an exemplary process 200 for playing the hidden objects video game. The game is launched by the user (also referred to as a game player) in block 202, and a background graphic along with various objects 106(a-c) are displayed in game window 102. In block 206, a list of objects 106(a-c) to be found in the game window 102 are displayed in list window 104. In block 208, a game player using an input device finds and then selects one or more of the various objects 106(a-c) from the game window 102 corresponding to objects in the list 108. The selected objects are removed from the list 108 in block 210. An indication of the selection (such as by animating the object) is performed in response to selecting an object in the game window 102.

In block 212, a determination is made whether all the objects have been removed from list 108. If not, the game player selects more objects from the list in block 208. If all objects have been removed, in block 214, a determination is made whether there is a new list/graphics window in which the game player can select new objects. If there are new list/graphics windows, a new game window 102 and list window 104 are displayed and blocks 204-212 are repeated. If there are not any additional list and game windows, the game ends in block 216.

### SUMMARY

A method computer-implemented method for playing a video game with a video playing device that includes a top screen and a bottom screen is disclosed. In the method, a background graphic design and partially hidden objects embedded in the background graphic scene on both the top screen and the bottom screen are displayed. The bottom screen displays a zoomed cropped view of the top screen. On the top screen, items corresponding to the partially hidden objects are displayed in a textual list. The game player, using an input device, changes the bottom screen display to another zoomed cropped view of the top screen. The game player selects the partially hidden objects in the bottom screen. Finally an indication is provided as each of the partially hidden objects is selected.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 depicts an illustrative screen of a prior art version of the hidden object video game.

FIG. 2 depicts an illustrative process for playing the prior art hidden object video game.

FIGS. 3a, 3b, 4a, 4b, 5a, 5b, 6a, 6b, 6c, 7a, and 7b are a depiction of screen shots illustrating various embodiments in playing the dual screen hidden object video game.

FIG. 8 is a depiction of an electronic device used for playing the dual screen hidden object video game.

FIGS. 9a-9c depict flowcharts for implementing the hidden object video game in accordance with the disclosed embodiment.

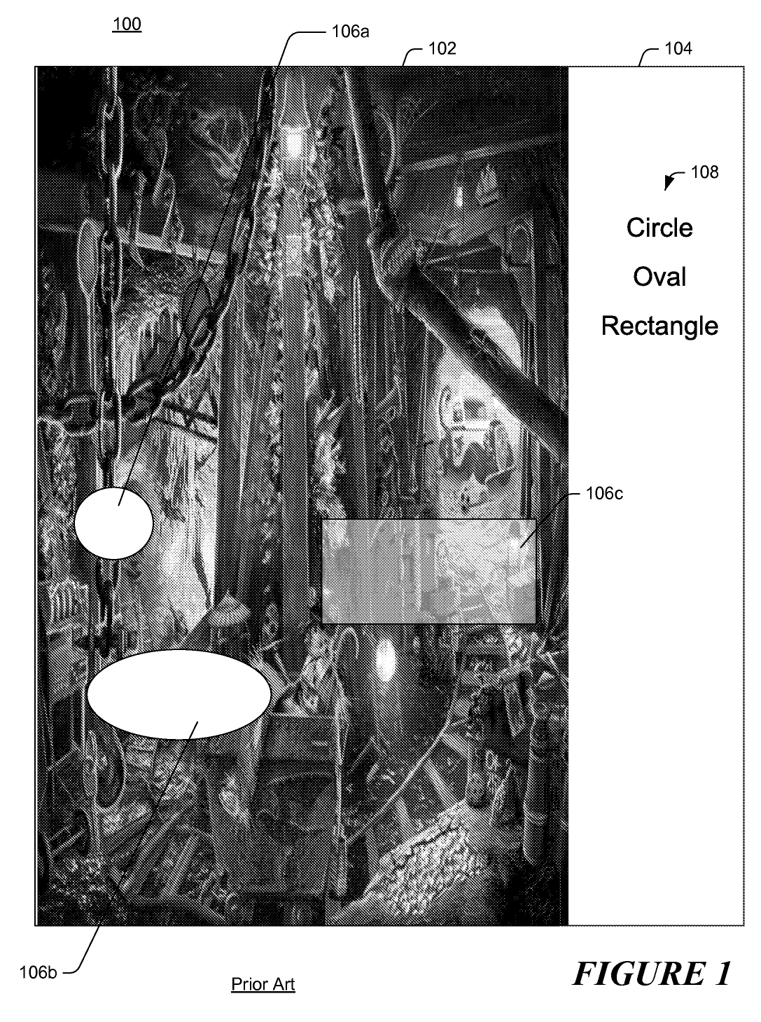

### DETAILED DESCRIPTION

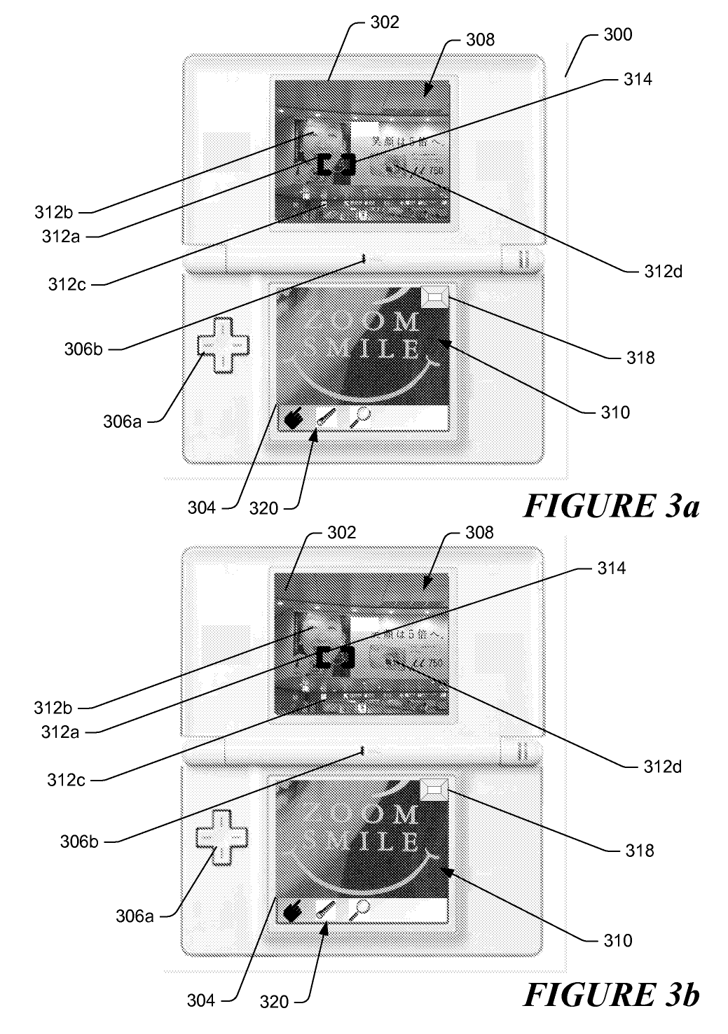

The following document describes method(s) or software capable of instantiating a computer video game. The hidden object video game may be executed on any electronic device such as a computer, PDA, computer laptop or gaming device preferably having at least two screens. Various examples of the video game are described below with reference to FIGS. 3-9.

The construction of the video game and an environment in which this video game may be enabled by techniques is set forth first below. This is followed by others sections describing various inventive techniques and illustrative embodiments of other aspects of the video game.

Illustrated in FIG. 3a is an exemplary playing device 300 having a top screen 302, a bottom screen 304 and input devices 306a and 306b. Such playing devices include, but are not limited to, a Nintendo DS™ or Nintendo DS™ lite available from Nintendo Inc. of Redmond, Wash. Bottom screen 304 (or top screen 302) may be a touch screen display and provide an input signal when touched, such as by using a stylus. In one implementation, input device 306a is a cursor control device, and input device 306b is a microphone.

Displayed on the top screen 302 and bottom screen 304 are background graphic designs 308 and 310 respectively. Background graphic design 308 displays a scene in the video game. Embedded in graphic design 308 are partially hidden objects 312(a-n). The bottom screen 304 displays a zoomed cropped view of the top screen 302 that a game player may encounter when playing the dual screen hidden object game. This view of the bottom screen 304 is highlighted on the top screen 302 using brackets 314 to indicate the boundaries of the bottom screen 304 display.

Disposed on bottom screen 304 are icons of special objects 320 that can be activated by being selected by a game player. Examples of such special objects include a flashlight, a hand freeze frame indication or a magnifying glass. Selecting these special objects 320 changes a portion of the bottom screen's color, luminosity, or brightness.

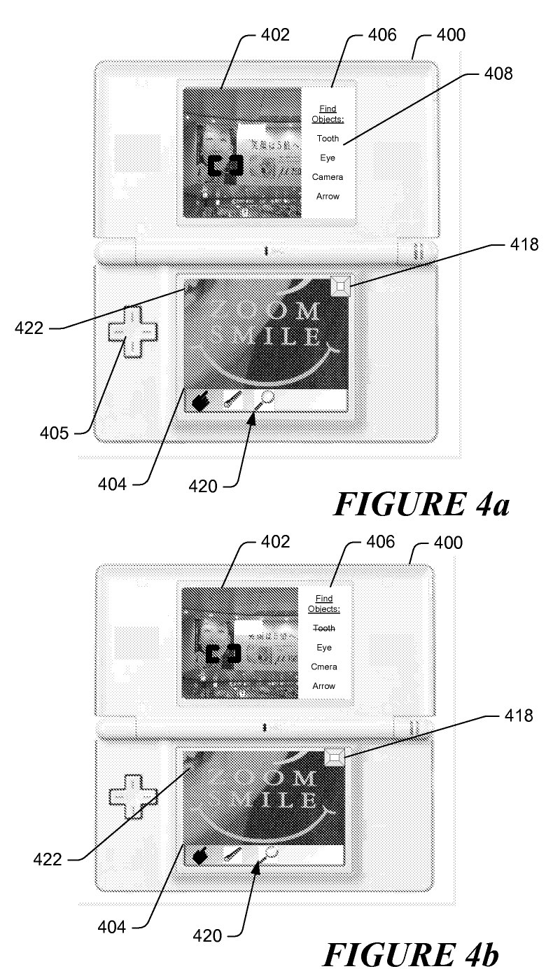

Also disposed on bottom screen 304 is text list selector button 318. When button 318 is selected, a textual list of the hidden objects 312a-d is displayed or removed from the top screen 302. Button 318 may be selected using input device 306a or by the game player touching the button 318 on the bottom screen 304 with a stylus. Further details of the use of the textual list are explained in FIGS. 4a-4b.

The view of bottom screen 304 is changed by the game player dragging an input device (not shown), such as a stylus, across the surface of the bottom screen 304. Referring to FIG. 3b, in response to dragging the input device, the view of the bottom screen 304 is changed to show a different zoomed cropped view of the top screen 302. In one implementation the amount the bottom screen 304 is zoomed in with respect to the top screen in fixed for the game. In another implementation, the zoom amount may be controlled by the game player. In addition the location of brackets 314 is moved on the top screen 302 to correspond to the cropped view on the bottom screen 304.

Illustrated in FIG. 4a is the game playing device 400 with the top screen 402, bottom screen 404 and input device 405. Displayed on the top screen 402 is a list of objects on textual list 406. During play of the game, the game player may select bottom screen 318 to display textual list 406. The textual list 406 is displayed in a special screen 408 that has a graphic background different than the graphic background of top screen 402. Also displayed on bottom screen 404 are special objects 420 that can be selected to change the display on screens 402 and 404, or to change an interaction with the bottom screen 404.

In one implementation, the width of the screen 408 is set to be as wide as the width of longest word on the textual list 406 of objects. Upon selection of button 418 by the game player, a special screen 408 appears, and as a result the width of the graphic image on top screen 402 is shrunk proportionally to the increase of special screen 408. If button 418 is selected again, special screen 408 is removed and the width of the graphic image on top screen 402 expands to fill the entire top screen 402.

During play of the game, the game player selects one of special objects 420 and then touches the bottom screen 404 with a stylus or depresses input device 405 to move the view of bottom screen 404. For example, the game player touches with the stylus one of the objects that appears on the bottom screen 404, e.g. tooth 422. Referring to FIG. 4b, there is shown an exemplary screen display after the “tooth” object as been selected. In this screen display, the object (tooth 422) is then crossed off of the textual list 406, is animated and is removed from both top screen 402 and bottom screen 404. Game play continues by the game player finding and selecting objects on the bottom screen 404, corresponding to objects on the textual list 406, until all the objects are removed from textual list 406 as well as screens 402 and 404.

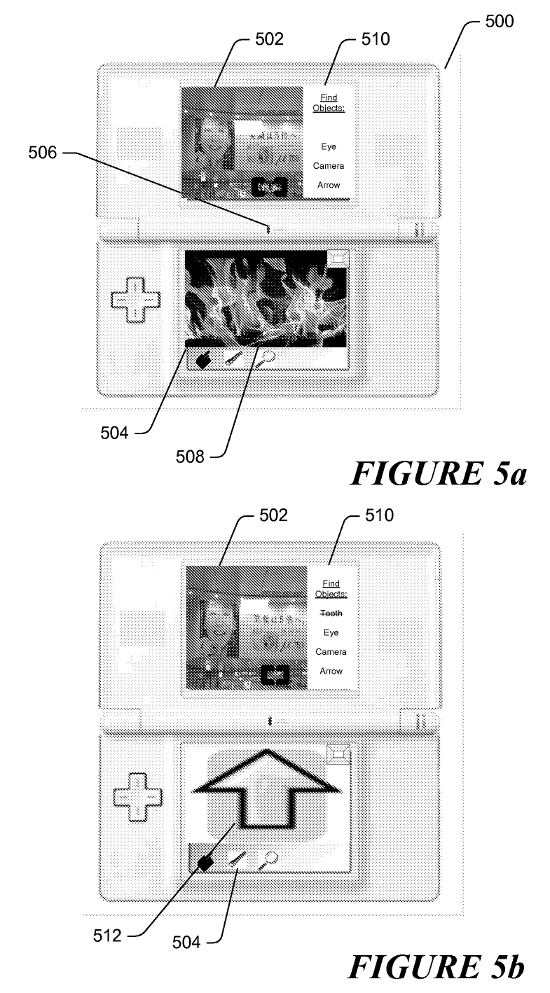

Illustrated in FIG. 5a is the game playing device 500 with the top screen 502, bottom screen 504 and a microphone input device 506. In one implementation an animated or non-animated object 508 may be displayed on the top screen 502 and bottom screen 504. The game player selects object 508 using the input device, such as a stylus, and then blows or talks into the input device 506 resulting in a change in the animation of the object 508. In one embodiment, the object 508 may be on the textual list 510, and removed upon blowing into the input device 506. Upon blowing into input device 506 while object 508 is selected, the object 508 may be removed. Referring to FIG. 5b, upon the object 508 being removed another hidden object 512 is revealed on both top screen 502 and bottom screen 504. This object 512 may be selected by the game player using a stylus, and then removed from list 510 upon selection.

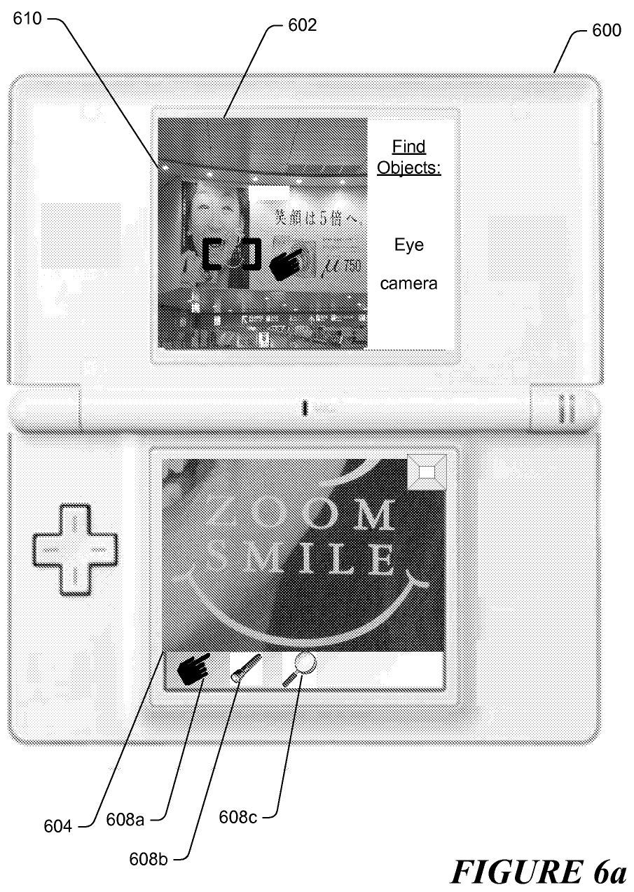

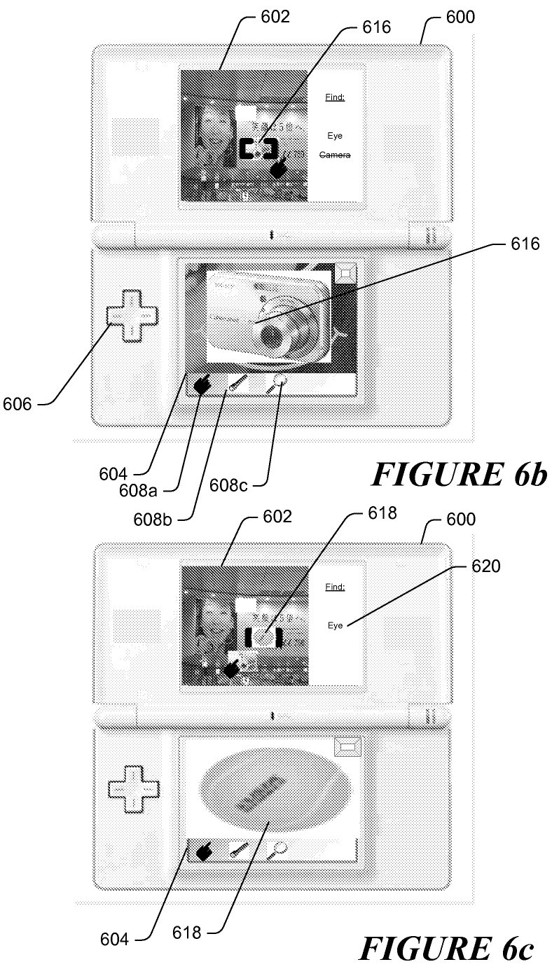

In another implementation as illustrated in FIG. 6a, there is shown the game playing device 600 with the top screen 602, bottom screen 604 and input device 606. In this implementation, the game player may select one of the special objects 608a-608c. One such special object the game player may select is a hand object 608a. When hand object 608a is selected, the views of the bottom screen 604 and the corresponding brackets 610 that indicate the view on the top screen 602 are locked.

Referring to FIG. 6b, once the bottom screen 602 and top screen 604 of game playing device 600 are locked, the game player may then, using the stylus (not shown), touch the object 616 or the input device to select the object 616 on the bottom screen 604. Upon selecting the object 616, either the object 616 or another object in the vicinity of the object 616 is animated and/or removed from the top screen 602 and bottom screen 604.

Referring to FIG. 6c, upon the removal of the object, another new object 618 may appear in place of the removed object 616 on the top screen 602 and bottom screen 604 of device 600. The new object 618 may also appear on list 620, such that when the new object 618 is selected, it is removed from the list 620 and bottom screen 604. In another implementation, when the new object 618 is selected the game player may be placed in a new virtual room by displaying a new graphic image and objects on top screen 602 and bottom screen 604.

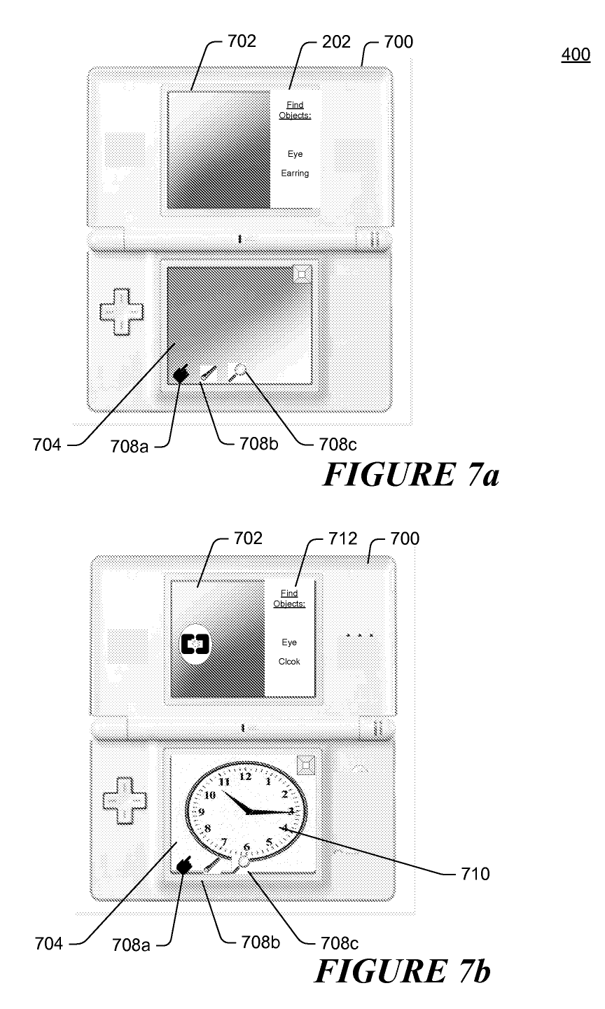

In a further implementation as illustrated in FIGS. 7a and 7b, there is shown the game playing device 700 with the top screen 702, bottom screen 704 and input device 706. In this implementation, the game player may select one of the special objects 708a-708c. One such special object the game player may select is a flashlight object 708b. Referring to FIG. 7a, before the flashlight object 708b is selected, the background image on screen 702 and 704 are shown as black. Referring to FIG. 7b, after the flashlight object 708b is selected, portions of the image on screens 702 and 704 are highlighted (such as displaying the room with a new color or luminosity) and one or more new objects, such as a clock 710, is displayed on both screens 702 and 704. The new object 710 may then be selected and removed from textual list 712. Once selected, object 710 may also be removed from screens 702 and 704.

### Example System Architecture

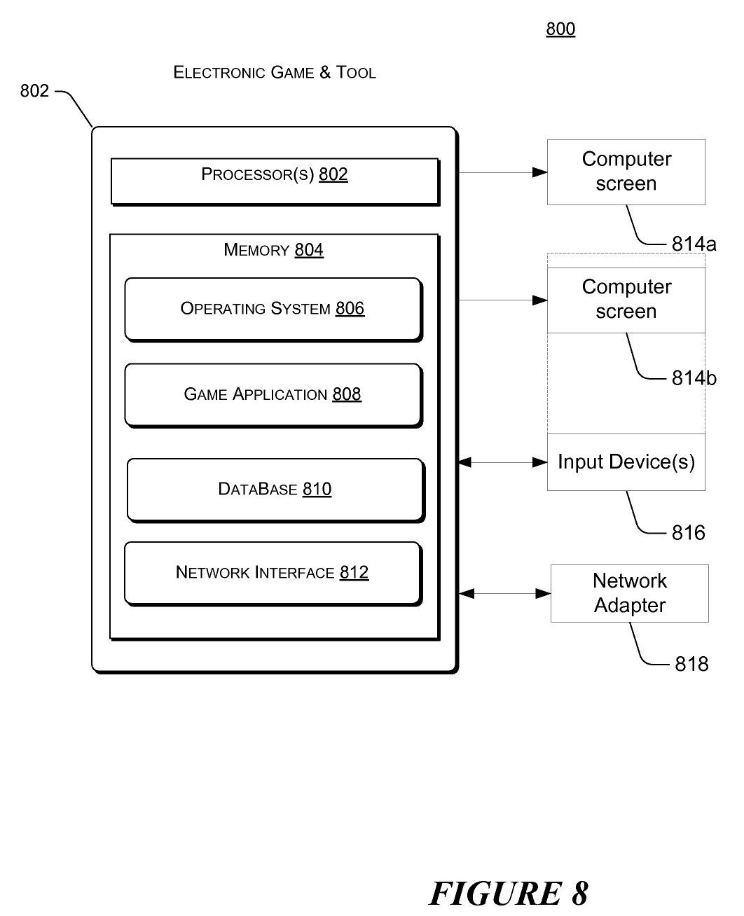

The computer environment 800 illustrated in FIG. 8 is a general computer environment that includes a user interface which can provide a computer video game to a game player. Similar resources may use the computer environment and the processes as described herein. The computer environment 800 is only one example of a computer environment and is not intended to suggest any limitation as to the scope of use or functionality of the computer and network architectures. Neither should the computer environment 800 be interpreted as having any dependency or requirement relating to any one or combination of components illustrated in the exemplary computer environment 800.

The computer environment 800 includes a general-purpose computing device in the form of a computer game playing device 802 (device 300 in FIG. 3). The playing device 802 can be, for example, one or more of a stand alone computer, laptop computer, a networked computer, a mainframe computer, a PDA, a telephone, a microcomputer or microprocessor, or any other computer device that uses a processor in combination with a memory. The components of the device 802 can include, but are not limited to, one or more processors or processing units 803 (also herein referred to as processor 803), a system memory 804, network interface 812 and a system bus (not shown) that couples various system components including the processor 803, network interface 808 and the system memory 804.

The memory 804 can comprise a variety of computer readable media. Such media may be any available media that is accessible by the playing device 802 and includes both volatile and non-volatile media, and removable and non-removable media. The process for creating and playing the video game can be stored as instructions sets on the computer readable media.

The system memory 804 may include the computer readable media in the form of non-volatile memory such as read only memory (ROM) and/or volatile memory such as random access memory (RAM).

The computer playing device 802 may also include other removable/non-removable, volatile/non-volatile computer storage media. By way of example, memory 804 may include a hard disk drive (not shown) for reading from and writing to a non-removable, non-volatile magnetic media (not shown), and an optical disk drive, for reading from and/or writing to a removable, non-volatile optical disk such as a CD-ROM, DVD-ROM, or other optical media. The hard disk drive and optical disk drive may each be directly or indirectly connected to the system bus.

The disk drives and their associated computer-readable media provide non-volatile storage of computer readable instructions, program modules, and other data for the computer playing device 802. Although the example depicts a hard disk within the hard disk drive, it is to be appreciated that other types of the computer readable media which can maintain for accessing data that is accessible by a computer, such as non-volatile optical disk drives, floppy drives, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computer environment 800.

Memory 804 may be a magnetic disk non-volatile optical disk, ROM and/or RAM. Stored in memory 804, including by way of example, may be an operating system (OS) 806, one or more video game applications 808, database 810 and network interface 812.

A game player can enter commands and information into the computer playing device 802 via input devices 816 such as a microphone, cursor controller keyboard and/or a pointing device (e.g., a “mouse”) which send a signal to the processing unit 803 in response to commands from the game player. Other input devices (not shown specifically) may include a joystick, game pad, satellite dish, serial port, scanner, and/or the like. These and other input devices are connected to the processing unit 803 via input/output interfaces (not shown) that are coupled to the system bus of computing device 802, but may be connected by other interface and bus structures, such as a parallel port, game port, or a universal serial bus (USB).

An LCD monitor, flat panel displays, touch screen displays, or other type of computer displays 814a and 814b can also be connected to the system bus via a video interface (not shown), such as a video adapter. In one implementation, display 814a is the top screen of the playing device 802, and display 814b is the bottom screen. In addition to the computer displays 814a and 814b, other output peripheral devices can include components such as speakers (not shown) which can be connected to the computer playing device 802.

The computer playing device 802 can operate in a networked environment using logical connections to one or more remote computers, such as a remote computer device through network adapter 818. By way of example, the remote computer device can be a personal computer, portable computer, a server, a router, a network computer, a peer device or other common network node, game console, and the like. The remote computer device can be a server that can include many or all of the elements and features described herein relative to the computer playing device 802.

Logical connections between the computer playing device 802 and the remote computer device (e.g. a service provider) are depicted as an Internet (or Intranet) which may include a local area network (LAN) and/or a general wide area network (WAN). Video game application 808 may be initially stored on the server and be downloaded from the internet onto memory 804 in computer playing device 802. Computer playing device 802 may communicate to the remote computer device using any communications media via network adapter 818 using network interface 812.

Various modules and techniques may be described herein in the general context of the computer-executable instructions, such as program modules, executed by one or more computers or other devices. Generally, program modules include routines, programs, control objects, components, control node data structures, etc. that perform particular tasks or implement particular abstract data types. Often, the functionality of the program modules may be combined or distributed as desired in various embodiments.

Operating system 806 manages the interaction between the various applications, modules and tools in memory 804 and devices 814-818. Operating system 808 may a window operating system built into the device 802 from Nintendo Inc. of Redmond, Wash. or may include a middleware interfaces. Game application 808 may communicate with the operating system directly or via the middleware interface. The place in the game of the game player may be stored in database 810.

An implementation of the aforementioned computer video game may be stored on some form of the computer readable media (such as optical disk) or transmitted from the computer media via a communications media to a game player computer. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any process or technology for storage of information such as computer readable instructions, control node data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer playing device.

Various modules and techniques may be described herein in the general context of the computer-executable instructions, such as program modules, executed by one or more computers or other devices. Generally, program modules include routines, programs, control objects, components, control node data structures, etc. that perform particular tasks or implement particular abstract data types. Often, the functionality of the program modules may be combined or distributed as desired in various embodiments.

### Exemplary Process

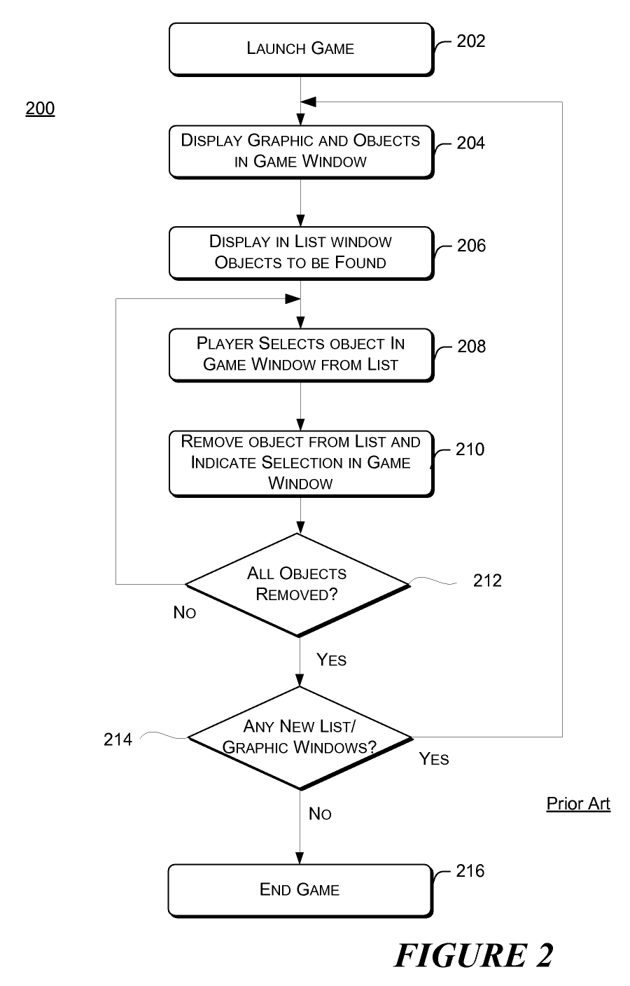

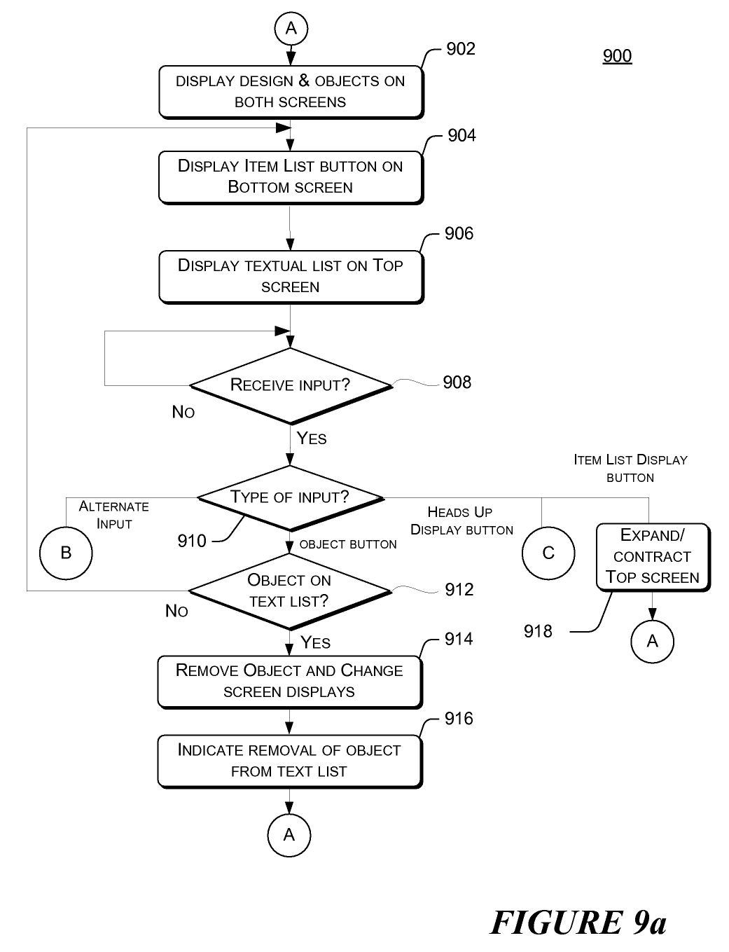

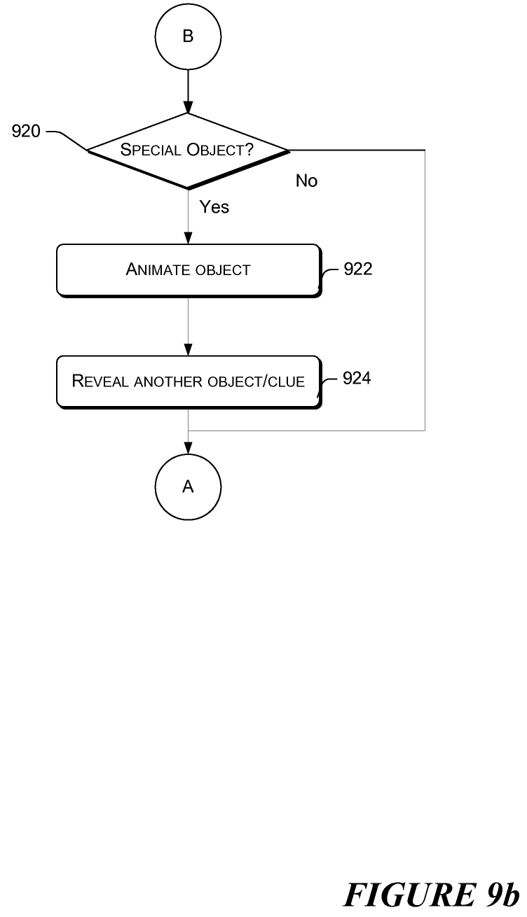

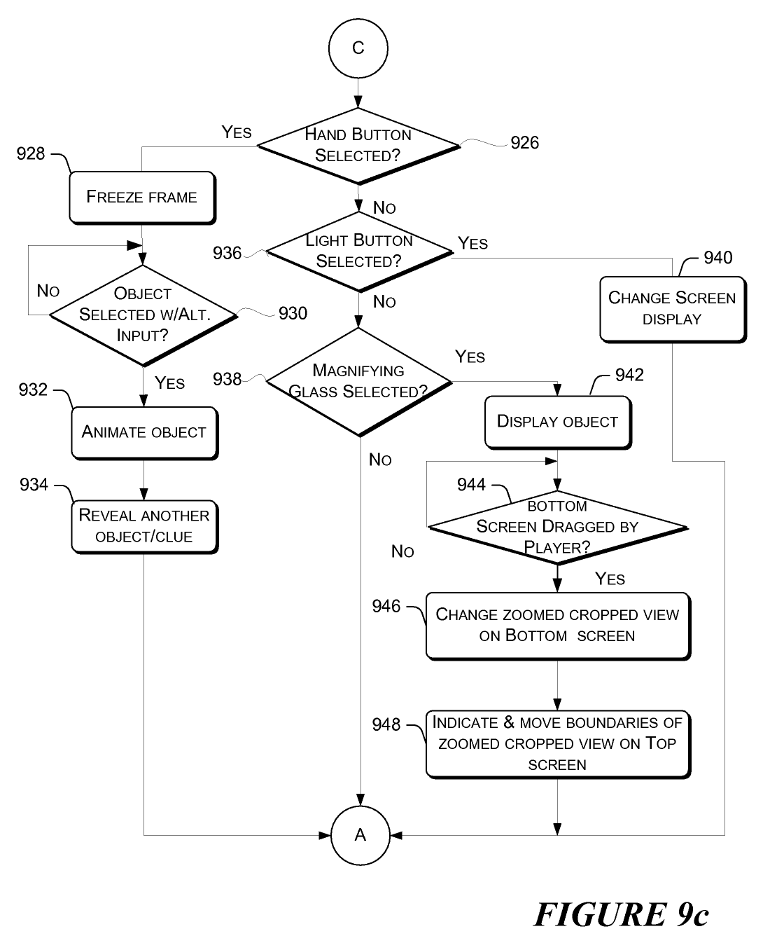

The exemplary processes, shown in FIGS. 9a-9c, are illustrated as a collection of blocks in a logical flow diagram. The flow diagram depicts exemplary processes 900-948 used by processor 803 in system 800 (see FIG. 8), to play the dual screen hidden object game and represents a sequence of operations that can be implemented in hardware, software, and a combination thereof. In one implementation the hidden object game is played using the methods described in FIG. 2 in combination with the method described in FIGS. 9a-9c.

In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to system 800 of FIG. 8, although it may be implemented in other system architectures.

Referring to FIG. 9a, the dual screen hidden object electronic video game is launched in block 902. When launched the top and bottom screens display both the background graphic designs and objects, in block 902. In block 904, the bottom screen displays the list button that when selected, displays the textual list of objects to be found and then selected. In block 906, the textual list of items to be found as well as the list background is displayed on the top screen along side the main graphic display that contains all of the objects to be found.

In block 908 a determination is made as to whether an input has been received from the game player using one of the input devices 816 or touch screen 814b. If no input is received form the game player (“no” to block 908), a determination continues to be made in block 908. Once an input is received (“Yes to block 910”), a determination is made as to the type of input in block 910. If the determination is made that there was an alternate input selection (“Alternative Input” to block 910), such as a microphone, the process proceeds to determine if there was a special object selected in block 920 of FIG. 9b. If there was an object selected (“object button” in block 910), then a determination is made whether the object is on the textual list in block 912. If there was a heads up display button selection (“Heads up display button” in block 910), then the process proceed to determine if there was use of a special hand display button in block 926. Finally, if there was an item list display button selected (“Item list display button” in block 910), then the top screen with the textual list of items is expanded (if the top screen was previously contracted or removed) or contracted/removed (if the top screen was previously present) in block 918. Then the process repeats from block 902.

In block 912, a determination is made whether the selected object was on the textual list. If it was not (“no” to block 912), then the process repeats starting by displaying the item list button on the bottom screen in block 904. If the object was listed on the textual list (“yes” to block 912), then in block 914, the selected object is animated and/or removed from the top and the bottom screen displays. The selected object is removed from the textual list of items on the top screen in block 916, and the process repeats starting at block 902.

Referring to FIG. 9b, a determination is made whether the special object was selected in block 920. If the special object was selected (“yes” to block 920), then in block 922 the special object is animated, and in block 924 another object and/or clue is revealed on the top and bottom display. If the special object was not selected (“no” to block 920) and after revealing another object/clue in block 924, the process then repeats starting at block 902.

Referring to FIG. 9c, if the process determines in block 926 that the hand was selected (“yes” in block 926), the top and bottom screens are temporarily frozen in block 928. Then in block 930, a determination is made whether the game player used an alternate input with a designated input object. Alternate inputs include the game player blowing or talking into the microphone or scraping multiple times (such as with a stylus) on the surface of the bottom touch screen. Once it is determined that the correct alternate input was used (“yes” to block 930), then in block 932, the selected object is animated and another object/clue is revealed in block 934. The process then repeats from block 902.

If in block 926, it was determined that there was no selection of the hand special object (“no” to block 926), in block 936 a determination is made whether a light special symbol or object was selected (e.g. a flashlight). If it was (“yes” to block 936), the top and bottom screen displays are modified to change color, or luminosity or to simulate shining a flashlight into a dark room. The process then repeats form block 902.

If the light special object was not indicated (“no” to block 936), then a determination is made in block 938 whether a magnifying glass special object was selected. If it was not (“no” to block 938), the process then repeats from block 902. If the magnifying glass special symbol was selected (“yes” to block 938), then the objects are displayed on both top and bottom screens in block 932. In block 944, a determination is then made whether the game player has attempted to drag the stylus across the surface of the bottom screen, or depressed the input device 405 (FIG. 4a). If the game player has dragged the screen, in block 946 the zoomed cropped view on the bottom screen is redrawn to display new objects and background graphics. In block 948, an indication of the change in the bottom screen is indicated on the top screen by moving the boundaries of the brackets corresponding to the view on the bottom screen. The process then repeats from block 902.

### CONCLUSION

Above is described an apparatus and method for playing a dual screen hidden objects computer implemented video game. These and other techniques described herein may provide significant improvements over the current state of the art, to enable game play of the hidden objects game on a portable device. Although the system and method has been described in language specific to structural features and/or methodological acts, it is to be understood that the system and method defined in the appended claims is not necessarily limited to the specific features or acts described. Rather, the specific features and acts are disclosed as illustrative forms of implementing the claimed system and method.

1. A method computer-implemented method for playing a video game with a video playing device that includes a first screen and a second screen, the method comprising:
displaying a background graphic design and partially hidden objects embedded in the background graphic scene on both the first screen and the second screen, the second screen displaying a zoomed cropped view of the first screen;
displaying, on the first screen, a textual list of items corresponding to the partially hidden objects;
in response to a game player input, changing the second screen display to another zoomed cropped view of the first screen;
selecting the partially hidden objects in the second screen; and
providing an indication when each of the partially hidden objects are selected.

2. The method as recited in claim 1 further comprising:
touching the second screen by a game player; and
selectively displaying on and removing from the first screen items on the textual list in response to the game player touching the second screen.

3. The method as recited in claim 2 further comprising displaying a button on the second screen that when touched by the game player, displays and removes the textual list on first screen and correspondingly collapses and expands a size of the scene displayed on the first screen.

4. The method as recited in claim 1 further comprising:
providing an indication on the first screen of at least boundaries of the zoomed cropped view; and
moving the boundaries when the second screen display is changed.

5. The method as recited in claim 4, wherein the second screen includes a touch screen, wherein the input device includes the touch screen and a stylus, and wherein the method further comprises changing a view of a scene on the second screen in response to the game player contacting the touch screen with a stylus and dragging the stylus across the touch screen.

6. The method as recited in claim 1 further comprising selecting the partially hidden objects in the second screen by a game player blowing on the video playing device.

7. The method as recited in claim 1 further comprising selecting the partially hidden objects in the second screen by a game player scraping one or more partially hidden objects on the second screen with a stylus.

8. The method as recited in claim 6 and 7 wherein in response to the device being blown or the second screen being scraped, changing animation of one of the partially hidden objects on the second screen.

9. The method as recited in claim 6 and 7 wherein in response to the playing device being blown upon or the screen being scraped, revealing another object behind the selected partially hidden object.

10. The method as recited in claim 1 further comprising providing an indication when one of the partially hidden objects is selected using the list in the first screen and the partially hidden object in the second screen.

11. The method as recited in claim 1 further comprising providing an indication when one of the partially hidden objects is selected by removing the item corresponding to the selected partially hidden object from textual list on the first screen and animating the partially hidden object on the second screen.

12. The method as recited in claim 1 further comprising providing a special object on the second screen that is selectable by the game player, selecting the special object and the partially hidden object on the second screen, and indicating when the partially hidden object and the special object is selected by the freezing the second screen and animating the partially hidden object on the second screen.

13. The method as recited in claim 12 wherein upon the partially hidden object being animated, indicating another object behind the animated partially hidden object.

14. The method as recited in claim 1 further comprising:
providing a special object on the second screen that is selectable by the game player, selecting the special object and the partially hidden object on the second screen;
indicating when the partially hidden object and the special object are selected by changing a portion of the second screen's color, luminosity, or brightness; and
highlighting objects in a changed portion of the second screen to reveal clues to the video game.

15. The method as recited in claim 14 wherein the highlighted objects are not visible before the portion of the second screen is changed.

16. A computer readable medium having instruction which when executed by one or more processor implement a video game with a video playing device that includes a first screen and a second screen, said instructions when executed by one or more processors comprise:
displaying a background graphic design and a partially obfuscated objects embedded in the background graphic design on both the first screen and the second screen, the second screen displaying a zoomed-in view of a portion of the first screen;
providing an indication on the first screen of at least boundaries of the zoomed-in view;
selectively displaying, on the first screen, a textual list corresponding to the obfuscated objects;
in response to a game player input, changing the second screen display to another zoomed-in partial view of the first screen and moving the boundaries on the first screen corresponding to the another zoomed-in partial view when the second screen display is changed;
selecting the obfuscated objects in the second screen corresponding to items on the textual list;
providing an indication on the second screen when the obfuscated object is selected; and
selectively displaying on and removing from the first screen items on the textual list in response to the game player selecting the obfuscated objects in the second screen corresponding to items on the textual list shown on the first screen.

17. The computer readable medium as recited in claim 16, wherein said instructions when executed by one or more processors further comprise:
providing a special object on the second screen that is selectable by a game player;
receive an indication of selecting the special object and the partially hidden object on the second screen; and
indicating when the partially hidden object and the special object is selected by the freezing the second screen and animating the partially hidden object on the second screen.

18. The computer readable medium as recited in claim 16, wherein said instructions when executed by one or more processors further comprise:
providing a special object on the second screen that is selectable by the game player, selecting the special object and the obfuscated object on the second screen;
indicating when the obfuscated object and the special object are selected by changing a portion of the second screen's color, luminosity, or brightness; and
highlighting objects in a changed portion of the second screen to reveal clues to the video game.

19. A video game device comprising:
a first video screen and a second video screen;
an input device;
a processor;
a memory comprising instruction which when executed by the processor comprise:
display a background graphic design and partially obfuscated objects embedded in the background graphic design on both the first screen and the second screen;
display on the second screen a zoomed-in view of the first screen;
display on the first screen, a textual list of items corresponding to the partially obfuscated objects;
receive a signal from the input device that indicates to change the second screen display to another zoomed-in view of the first screen;
receive a signal from the input device to select the partially obfuscated objects in the second screen; and
providing an indication on the first or second screen when each of the partially obfuscated objects are selected.

20. The video game player as recited in claim 19, wherein the second screen includes a touch screen; wherein the input device comprises a stylus and the touch screen; and wherein the memory comprises instructions which when executed by the processor selectively display on the first screen and removing from the first screen items on the textual list in response to the game player touching the second screen with the stylus.
